(19) United States
(12) Patent Application Publication
(10) Pub. No.: US 2017/0233198 A1
(43) Pub. Date: Aug. 17, 2017

(54) ZERO PRESSURE PNEUMATIC APPARATUS

(71) Applicant: Bulkmatic Transport Company, Griffith, IN (US)

(72) Inventors: Jeff Bingham, Hinsdale, IL (US); Scott Adams, Webster, TX (US)

(21) Appl. No.: 15/435,522

(22) Filed: Feb. 17, 2017

Related U.S. Application Data
(60) Provisional application No. 62/296,343, filed on Feb. 17, 2016.

(51) Int. Cl. B65G 53/16; B60P 1/56; B60P 3/22; B62D 63/08; B65G 47/18; B65G 53/46

(52) U.S. Cl. CPC B65G 53/16; B65G 47/18; B65G 53/4608; B60P 3/225; B62D 63/08; B60P 1/56; B60P 3/2205; B60P 3/2245; B60P 3/2265

(57) ABSTRACT

A simple and lightweight solution to the storage and delivery of dry flowable materials that is cost-effective, can be standardized to facilitate transportation and isolates the materials from exposure to air, insects and other contaminants. An apparatus includes a vessel and a delivery assembly, having a rotary feeder that upon gravity discharge of the dry flowable material moves such material to a desired location.

### CROSS-REFERENCE TO RELATED APPLICATIONS

This application claims the benefit of and priority from U.S. application Ser. No. 62/296,343, filed Feb. 17, 2016, which is hereby fully incorporated herein by reference.

### FIELD OF THE DISCLOSURE

This disclosure relates to an apparatus for storage and delivery of dry flowable materials. More particularly, this disclosure relates to an apparatus including an hopper assembly configured either as a frame supporting a vessel that stores and facilitates transport of dry flowable materials that fits within a volume defined by a standard sized intermodal container or a trailer having a vessel that stores and facilitates transport of dry flowable materials, and a delivery assembly configured to pneumatically convey the dry flowable materials from the vessel, without pressurizing the hopper vessel.

### BACKGROUND

Conventionally, dry flowable materials, such as granular chemicals or plastics, polymers, agricultural products, mineral products, etc., are moved in bulk form from a manufacturing facility or a distribution center to an end user by a trailer that has been manufactured as a pressure vessel. For example, see a conventional trailer illustrated in FIG. 1.

In order to deliver or unload the materials, air pressure in the range of 3-15 pounds per square inch (psi) is applied to the vessel on top of the materials. The pressure differential enables materials to be discharged from the pipe that connects the cones on the bottom of the trailer. As a result, at least one person is required to monitor the trailer pressure and to operate the trailer valves during the delivery process. Another disadvantage is that the conventional trailer, since it is configured as a pressure vessel, is reinforced, heavy and expensive. Consequently, the total payload capacity for the dry flowable material is reduced.

Alternately, conventional vehicles such as a dump truck or dump trailer may facilitate movement of dry flowable materials to a delivery point. However, such vehicles do not prevent exposure of the materials to air, insects or other contaminants during storage or transportation. Additionally, such vehicles cannot and do not provide any of the advantages of the apparatus disclosed herein.

Therefore, there is a need in the art for a simple and lightweight solution to facilitate the storage, transport and delivery of dry flowable materials that is cost-effective, standardized and that overcomes the disadvantages of the complex, lacking and costly prior art systems.

This disclosure consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 illustrates a conventional trailer for dry flowable materials.

FIG. 2 illustrates a side elevation view with a partial cross section view of one embodiment of an apparatus for transportation, storage and delivery for dry flowable product in accordance with this disclosure.

FIG. 3 illustrates a perspective view of an apparatus for transportation, storage and delivery for dry flowable product in accordance with this disclosure.

FIG. 4 illustrates a side elevation view of the apparatus of FIG. 3.

FIG. 5 is an end elevation view with a partial cross section view of the apparatus of FIG. 2.

FIG. 6 is an end elevation view of the apparatus of FIG. 3.

FIG. 7 illustrates a rotary valve configured to facilitate delivery operation of the dry flowable product in accordance with the present disclosure.

FIG. 8 illustrates a side elevation view of another embodiment of an apparatus for transportation, storage and delivery for dry flowable product in accordance with this disclosure.

FIG. 9 illustrates a side elevation view of another embodiment of an apparatus for transportation, storage and delivery for dry flowable product in accordance with this disclosure.

FIG. 10 illustrates another side elevation view of the apparatus of FIG. 9.

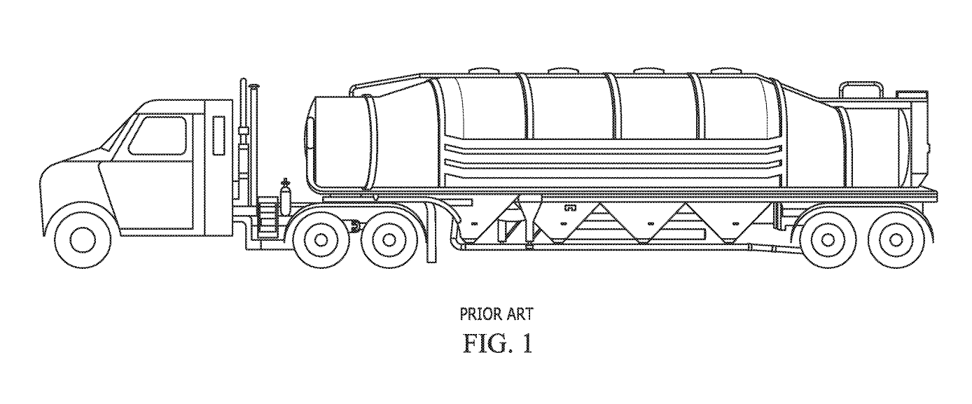

### DESCRIPTION OF THE PREFERRED EMBODIMENTS

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

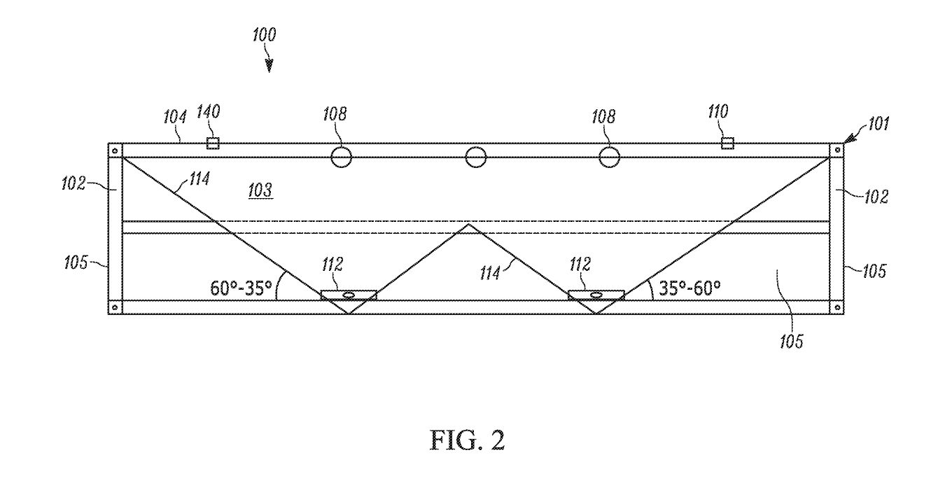

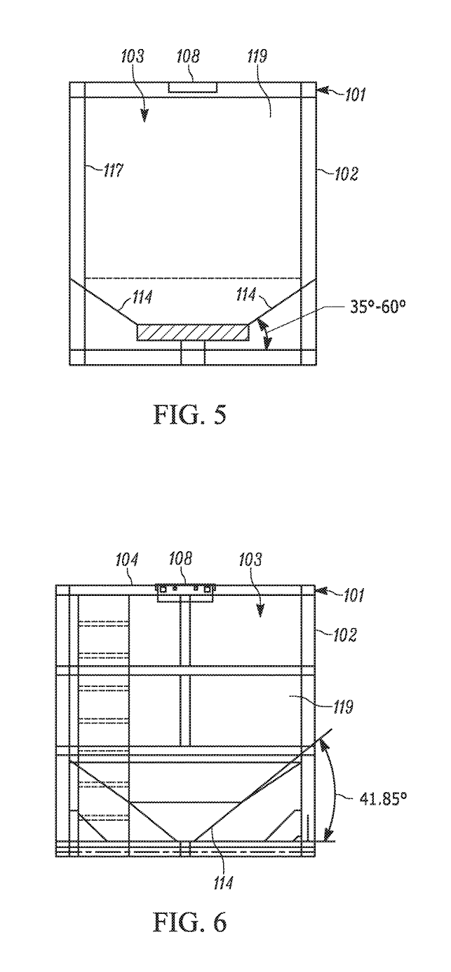

FIGS. 2 and 5 illustrate one embodiment of an apparatus for transportation, storage and delivery for dry flowable product in accordance with this disclosure that is configured to have outside dimensions that fit within a volume defined by a standard sized intermodal container and includes a vessel for the storage and transport of dry flowable materials. A complementary delivery assembly is configured to couple to the vessel and pneumatically convey the dry flowable materials out of the vessel without pressurizing the container, as described herein.

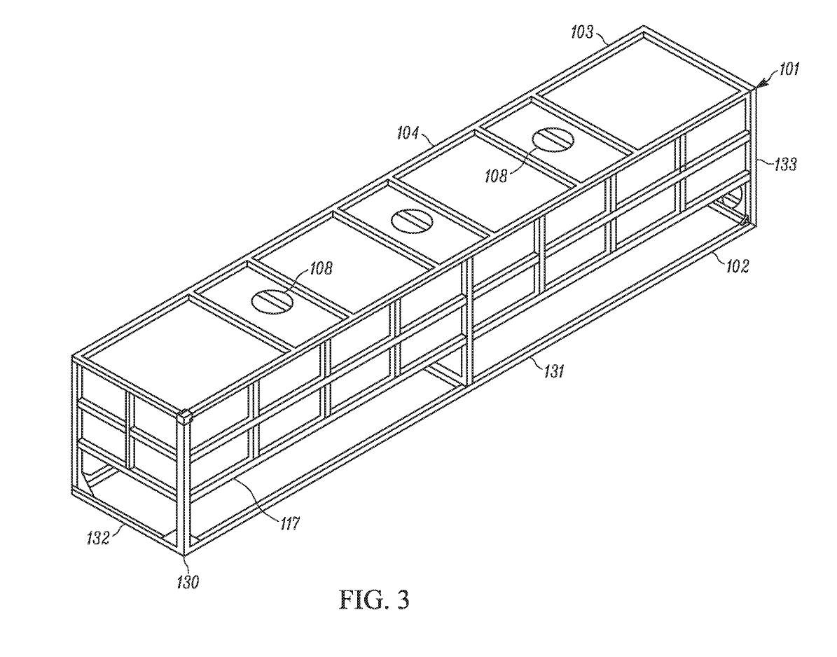

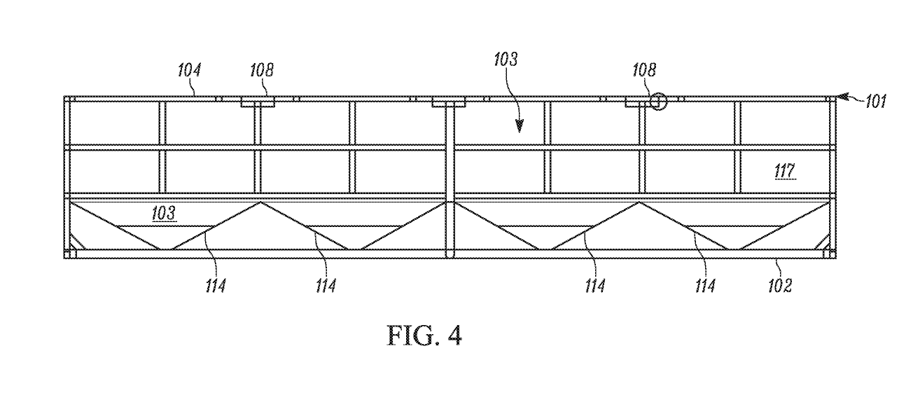

FIGS. 3, 4 and 6 each illustrate view of another embodiment of an apparatus for transportation, storage and delivery for dry flowable product in accordance with this disclosure that is configured to have outside dimensions that fit within a volume defined by a standard sized intermodal container and includes a vessel and complementary delivery assembly configured to couple to the vessel and pneumatically convey the dry flowable materials out of the vessel without pressurizing the container, as described herein.

An intermodal container is a shipping container having standardized dimensions (i.e., International Standards Organization ISO 668) that are designed and built for freight transport regardless of the means, i.e., these containers are adapted to be used across different modes of transport—from ship to rail to intermodal chassis—without unloading and reloading their cargo by having standardized corners to facilitate connection to one another or a chassis (i.e., International Standards Organization ISO 1161). Intermodal containers are primarily used to store and transport materials and products efficiently and securely in the global containerized intermodal freight transport system. Ninety percent of the global container fleet are so-called “dry freight” or “general purpose” containers that are configured as durable closed steel boxes, in certain standard lengths, mostly either twenty, forty or fifty three foot (6, 12 or 16 meters) in length. A standardized shape is beneficial for reasons set forth above. However, the standardized shape represents a bare rectangular volume with doors on an end. These containers can store and transport dry flowable materials, but the only way the container can be emptied is to have the necessary equipment to tilt the container or stand it up on its end. Consequently, to only way to make deliveries directly to a customer facility with a conventional intermodal container requires a giant plastic bag installed in the container which is then filled with the product. A specialized tilt chassis and/or tractor mounted lift system is also required which is heavy, expensive and unable to be used if the customer unloading are is not completely flat.

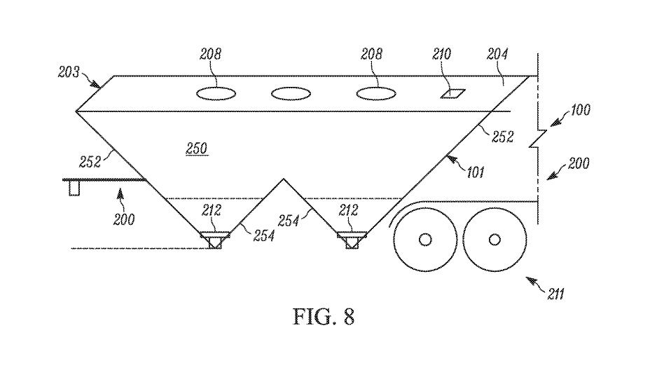

FIG. 8 illustrates another embodiment of an apparatus for transportation, storage and delivery for dry flowable product in accordance with this disclosure that is configured as a trailer including a frame having a wheel and tire assembly, where a vessel is connected to and supported by the frame. A complementary delivery assembly is configured to couple to the vessel and pneumatically convey the dry flowable materials out of the vessel without pressurizing the container, as described herein.

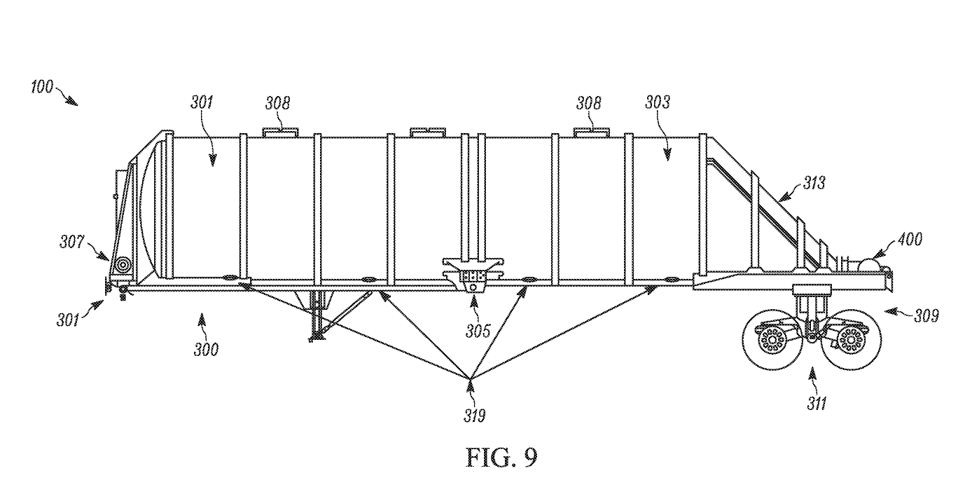

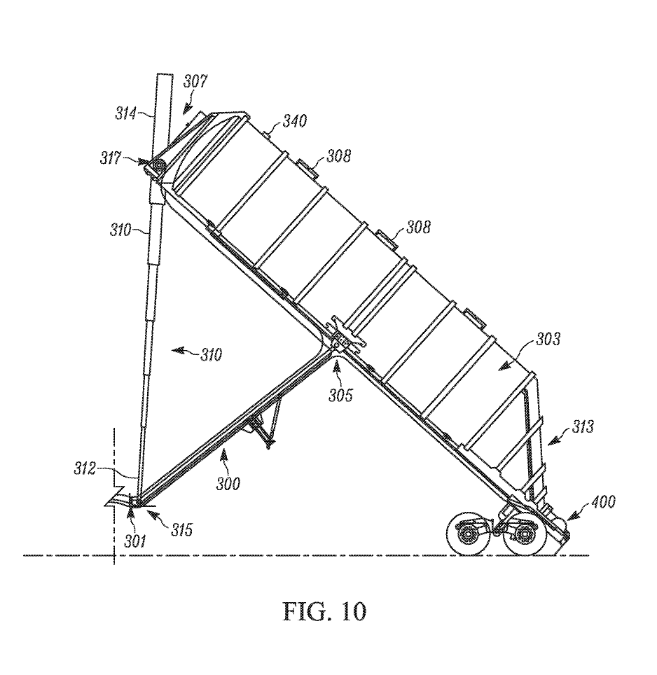

FIGS. 9 and 10 illustrate another embodiment of an apparatus for transportation, storage and delivery for dry flowable product in accordance with this disclosure that is configured as a trailer including a partial frame pivotally connected to a vessel that is configured as a stressed member and to which a wheel and tire assembly is connected. A lift cylinder or column is connected to the frame and vessel and a complementary delivery assembly is configured to couple to the vessel and pneumatically convey the dry flowable materials out of the vessel without pressurizing the container, as described herein.

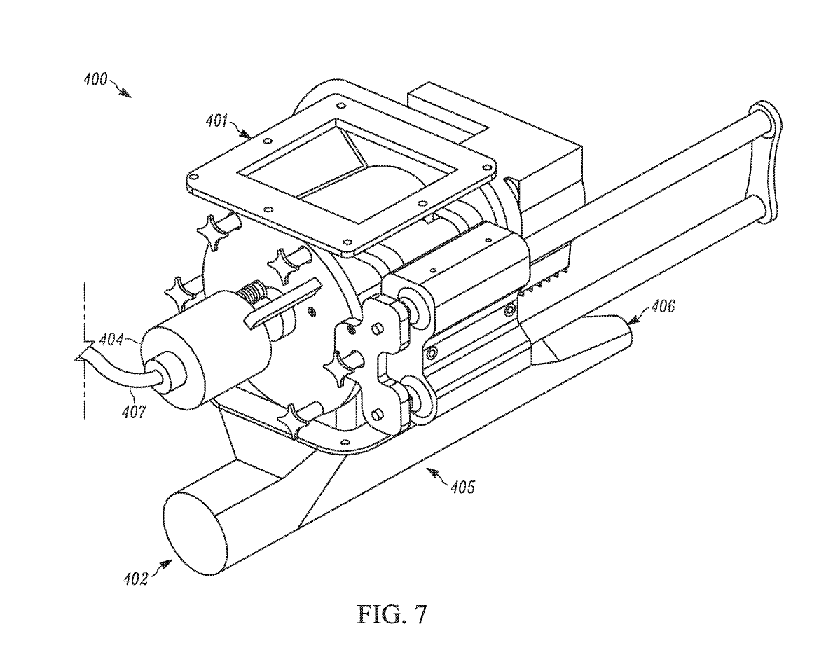

In the present disclosure, the apparatus 100 includes a vessel 103, 203, 303, that may have a substantially hopper 101 or cylindrical 301 configuration, and frame 102 supporting a vessel 103 for the storage, transport and delivery of dry flowable materials. In certain embodiments, the apparatus 100 fits within a volume defined by a standard sized intermodal container (as shown in FIGS. 2-6, i.e., ISO 668), and in others the frame is configured as what is more commonly understood to be referred to as a trailer 200, where the frame 200, 300 is connected to and supports the vessel 203, 303 and includes a wheel and tire assembly 211, 311 (as shown in FIGS. 8-10). A delivery assembly as shown in FIG. 7, is configured to pneumatically or hydraulically convey the dry flowable materials from the vessel 103, 203, 303, without pressurizing the vessel 103, 203, 303.

In the embodiment shown in FIGS. 2 and 5, the apparatus 100 includes a vessel 103 that is configured substantially as a hopper 101, and a frame 102. The outer or exterior dimensions of the frame 102 define top and bottom planes, end planes disposed normal (or perpendicular) to the top and bottom planes and side planes disposed normal to the end planes. The frame 102 also may have exterior side, end, and bottom panels 105 connected thereto to fully enclose the vessel 103 such that the apparatus 100 is configured to have outer dimensions that fit within the envelope of a standard intermodal container as per ISO 668, for example only 40 feet—8.85 feet—7.7 feet as shown. One of skill in the art will recognize that other standardized dimensions may be successfully used in connection with this disclosure as per ISO 668. The standardized dimensions and strength requirements facilitate movement of the apparatus through the intermodal industry, e.g., ship, rail and trucking, since it will fit in a standard intermodal stacking, crane fixtures, chassis and railcar. Preferably, the frame 102 may also include standard intermodal corner castings in compliance with ISO 1161 at each corner to facilitate connection with standard container lift systems, fixtures, mounting connectors, etc. and fitment to an intermodal container chassis for transport by a tow vehicle. In one embodiment, the apparatus 100 may include substantially conventional side and end walls, such that from all outward appearances the apparatus 100 is a standard intermodal container. Other embodiments of this apparatus 100 may be, for example only, 20, 48 and 53 foot length options.

In another embodiment, for example in FIGS. 3, 4 and 6, the apparatus 100 may include no exterior side, end or bottom panels where the frame 102 is configured with corner castings 130, side rails 131, end rails 132, corner posts 133, headers 131, sills 131, etc. to function as an exoskeleton of connected castings and tubing to protect the vessel 103 disposed therein.

The vessel 103, in either of the embodiments identified above, may include top, bottom (or inclined interior) and/or side walls 104, 114, 117 that define an enclosed volume of approximately 1500-1650 cubic feet for the dry flowable material. Preferably, the top wall 104 is parallel to the top plane, the side walls 117, disposed between the top 104 and bottom 114 walls, are parallel to the side planes, and the bottom walls 114 are disposed at an angle with respect to the bottom and top planes. End walls 119 may also be disposed between the top 104 and bottom 114 walls parallel to the end planes.

The bottom walls 114 are inclined to with respect to the bottom panel 105 in order to funnel the dry flowable material to cooperatively define an opening disposed at a lowermost extent of a plurality of the bottom walls 114 so that the dry flowable material may be discharged or delivered from the vessel 103. The openings preferably have a valve 112 (see FIG. 2, which is the same as set forth in FIGS. 3, 4 and 6, and may include a plurality of valves 112) configured as a slide gate, butterfly or hopper valve or the like, etc. connected to the plurality of adjacent the inclined bottom interior walls 114 about and aligned in registration with the opening to seal the opening from unintended release of any of the dry flowable product when in storage or transportation configurations. Preferably, the valve 112 is selectively operable between open and closed orientations. The valve 112 may be configured to facilitate a positive, sealed or limited leakage connection with a delivery assembly that is configured to pneumatically convey the dry flowable materials from the vessel, without pressurizing the hopper vessel 103. Preferably, the bottom walls 114 are inclined between 35-60 degrees with respect to the horizontal plane or bottom panel 105. In one embodiment, two valves 112 are used where there is a pair of sets of inclined interior walls 114, each associated with one of the pair of sets of inclined walls 114. Additionally, as shown in FIG. 5, further inclined interior bottom walls 114 extend from the side walls to the valve 112 that are similarly inclined, such as from the ends of vessel 103.

The top wall 104 preferably includes openings so that the vessel 103 can be easily filled with the dry flowable product and a suitable cover for such openings is also preferred. For example only, dome lids 108 that are pivotally connected to the top wall 104 permit (i.e., open orientation) and restrict (i.e., closed orientation) access to an opening formed in the top wall 104 under the lid 108. A rupture disk 110 may also be provided as a safety measure to prevent the build-up of unwanted pressure within the vessel 103. Further, a filtration assembly 140 may be included to assist with the buildup of unwanted pressure, but also to filter ambient air entering and leaving the vessel 103, primarily in order to prevent the dry flowable material from being contaminated.

In the embodiments shown in FIGS. 2-6, the tow vehicle, truck, tractor or prime mover is commonly a basic vehicle used in the transportation of containers between and among intermodal facilities and is not considered or appropriate for over-the-road or long distance duties. Accordingly, such vehicles have not only fewer driver amenities, but also reduced functionality in comparison to over-the-road trucks. The delivery assembly 400, as shown in FIG. 7, preferably includes a rotary valve or feeder 401 or other similar device or assembly having an inlet that is configured to align in registration with the valve 112 to facilitate unrestricted movement of the dry flowable material from the vessel 103, through the valve 112 into the rotary feeder 401. The delivery assembly also includes a discharge plenum 405 connected to an outlet of the rotary valve 401 that includes a discharge port 402 and an air inlet port 406, a discharge, delivery or unload hose (not shown for simplicity, but commonly understood, by one of skill in the art, and configured for connection to the discharge port 402 or the air inlet port 406 if a series of rotary valves 401 are used), and an air conveyance hose (not shown for simplicity, but understood by one of skill in the art upon further description below and configured for connection to the air inlet port 406 or at least one air inlet port 406 in the event a series of rotary valves 401 are used). Preferably, the delivery assembly 400 would be available at the delivery location so that it can be attached to the apparatus 100 upon arrival for discharge of the dry flowable material into the storage facilities of the delivery point. Alternatively, dedicated trucks can carry the delivery assembly 400 on-board.

The rotary feeders 401 may function either by electrical, pneumatic or hydraulic actuation 404. Cable or hose 407 connects to the actuator 404 to functionally activate the rotary feeder 401. For example, hose 407 may connect at an opposite end to a power take-off that provides pressurized hydraulic fluid from a tow vehicle, truck, tractor or other prime mover on-board system or a compressor that provides pressurized air from an on-board system. Alternatively, the cable 407 may connect at an opposite end an electrical source. However, most trucks that move the apparatus 100 as shown in FIGS. 2-6 usually do not generate enough electrical power to adequately actuate a rotary valve necessary to convey, discharge or deliver the dry flowable materials, and, for safety reasons, there is usually not an electrical outlet (or an outlet with sufficient load capacity) anywhere near where the dry flowable materials are unloaded, delivered, etc. Thus, electrical actuation in connection with the apparatus of the present disclosure has significant disadvantages. Additionally, such intermodal trucks also do not have hydraulic “wet kits” which are heavy and messy to operate and clean up or which would be anywhere near sufficient for the operation of a rotary feeder 401 much less a series of rotary feeders 401.

The present disclosure proposes, for the embodiments shown in FIGS. 2-6, a plurality of small rotary valves 401 that are commonly pneumatically operated by a pressurized air system found on nearly every truck. Modifications to the air system are minimal, in that a tap to connect a pressurized air source, such as the air compressor outlet of the pressurized air storage tank is all that is required. Rotary valves pneumatically operated by pressurized air can be smaller and lighter, and thereby easier to install and remove. By configuring multiple rotary valves in-line, the system will provide the discharge capacity of a much larger valve. Additionally, the plenum 405 facilitates connected of the plurality of valves 401 to a common discharge (i.e., in series with one another) with at least one air inlet 406 connected to the pressurized air source or a blower found at a delivery site, which functions as a secondary pressurized air source that facilitates movement of the dry flowable product from the rotary valves 401 to the storage location, silo, compartment, etc. or the like since the blower can provide a greater volume of air necessary in order to provide in intended functionality.

The unloading system of valves and pipping is easily removable from the apparatus 100 since the apparatus 100 must be fitted to an intermodal container chassis in order to be mobile. The unloading delivery assembly system is preferably installed on the vessel before shipment thereof to the recipient, or at the recipient's facility, and may be removed from the apparatus after the delivery is made. A delivery assembly 400 including a pneumatically operated rotary valve 401 is connected to each valve 112 and then connected to a single discharge or unload line, hose, conduit, etc. at the discharge port 402, which may connect to an inlet port 406 of an adjacent rotary valve 401 in series. The operator then connects a hose at one end to a source of pressurized air, that is either stationary at the customer, recipient, delivery location, or on the tow vehicle to the air inlet port 406 of each valve 401, but more likely to at least one valve 401 if there is a series of valves 401, and actuates the air source to move air through the discharge or unload line, hose, conduit, etc. The pressurized air from the air source carries the product from the rotary valve 401 into the storage location. The operator then confirms that the air source hose (either stationary or on the tow vehicle) is connected to each rotary valve 401 and that the air source is activated in order to actuate the rotary valves 401. The valves 112 are then moved to the open orientation and, after the valve 112 is opened, the dry flowable materials will flow into the top of the pneumatically operative rotary valve 400 by gravity and be moved into the discharge hose via port 402 for delivery to its intended unload location. Usually, the dry flowable material is discharged from the hopper 101 only when at a delivery location, where in such instance the hopper 101 will be secured to a chassis that is configured to mount standard intermodal containers.

The delivery assembly 400 may be carried on the chassis onto which the apparatus 100 is mounted, the tow vehicle that pulls the chassis or stored at the delivery location depending on the volume of dry flowable material that is delivered to such location on a periodic basis, customer preference, etc. However, since the enclosed volume of the vessel 103 is not pressurized, and is in fact vented to atmosphere, the unloading, discharge or delivery of the dry flowable materials within the vessel 103 is not required to be monitored by at least one person and can occur without any supervision after the delivery assembly is properly connected and activated. After the vessel 103 is emptied, the operator will close the valves 112, de-activate the rotary valves 400 (i.e., remove or disconnect the source of pressurized air), stop and disconnect the air source, the delivery assembly may be disconnected from the vessel 103 at this time, or at another time.

As will be recognized from FIG. 8, in another embodiment the apparatus 100 may be configured to include a trailer that includes a frame 200 (shown only in partial schematic representation to avoid confusion and for simplicity, but would be commonly understood by one of skill in the art based upon the description herein), that includes structure (e.g., tongue, tow bar, king pin, etc.) to facilitate connection of the trailer to a truck or other prime mover, structure to mount a load bearing wheel and tire assembly 211, and a vessel 203, configured substantially as a hopper 101 similar as shown in FIGS. 2-6, for the dry flowable material substantially as described as above.

This embodiment is similar in concept to the prior embodiment of FIGS. 2-6, except it is not constrained by the standardized dimensions of an intermodal container and does not use the various castings, tubing, exoskeleton, side, end and bottom walls found in the prior embodiment. Accordingly, the enclosed volume can be greater (e.g. approximately 1500-2000 cubic feet) when the dimensions of the enclosed volume are approximately 36 feet long×8 feet wide×12 feet high. Basically, the structure of the trailer 200 is provided only to support the vessel 203 which enables a very lightweight construction, including, but not limited to the use of aluminum, polymers and other materials of the like, etc. One of skill in the art will recognize that the dimensions of this embodiment may be adjusted to facilitate the intended functionality, perhaps only limited by the federal, state, or local laws, rules and regulations directed to size of vehicles that travel upon roadways, including but not limited to any requirements for size and strength administered by the US Department of Transportation, Transport Canada, Transportation Safety Board of Canada, Secretaria de Comunicaciones y Transportes (SCT) [Ministry of Communications and Transportation in Mexico], Dirección General de Autotransporte Federal (DGAF) [General Directorate of Federal Motor Carriers in Mexico], or any other similar or related requirement or entity.

A top wall 204 must include openings so that the vessel 203 can be filled with the dry flowable product and a suitable cover for such openings is also preferred. For example only, dome lids 208 that are pivotally connected to the top wall 204 permit and prevent access to an opening formed in the top wall 204. A rupture disk 210 may also be provided as a safety measure to prevent the build-up of unwanted pressure within the apparatus 100.

Side, end and intermediate walls 250, 252 and 254 are configured substantially the same as a hopper 101 as shown in the prior embodiment to define the vessel 203. However, in one embodiment a preferred angle of inclination of 45-65 degrees may be provided to funnel the dry flowable materials into the valves 212 (which are similar configured as otherwise described herein). Preferable, in every embodiment, the valves 212 are disposed at least 18 inches above a reference ground surface and configured to couple to the delivery assembly as described otherwise herein.

The delivery assembly 400 and the associated loading and unloading process is the same as described above and will not be repeated for the sake of brevity, but all of the advantages are equally applicable in this embodiment.

As will be further recognized in FIGS. 9 and 10, in another embodiment the apparatus 100 may be configured substantially as a trailer that includes a partial frame 300 that is pivotally connected to the vessel 303 near a mid-point 305 thereof and has a connection block 301 at an opposite end to facilitate selective connection to a tow vehicle, truck or other prime mover (such as a king pin) and a bulkhead 307 connected to an adjacent end of the vessel 303 that also facilitates raising or lifting of such end of the vessel 303 (as shown in FIG. 10), structure 309 for an articulable mounting of a load bearing wheel and tire assembly 311 to the vessel 303, and the vessel 303 for the dry flowable material substantially as described as above but preferably more cylindrical for a substantial portion of its length and constructed so as to function as a stressed member able to support the weight of its structure, the dry flowable contents, and the associated components of the trailer and including a rear section 313 disposed adjacent the wheel and tire assembly 311 that smoothly transitions from the generally cylindrical configuration to an interface with an installed rotary valve 400 (substantially as described with respect to FIG. 7) and functions substantially as a funnel, i.e., tapering so as to reduce cross-sectional area as the vessel 303 transitions to the opening for the rotary valve 300, as shown in FIG. 10.

The bulkhead 307 may include an extendible lift column 310 that may be multi-segmented or include a number of nesting components where the bottom or innermost component 312 is movably connected to the mounting block 301 at the end 315 of the frame 300 opposite the mid-point 305 and the top or outermost component 314 is movably connected to the bulkhead 307 by a trunnion or pivot point 317. The column 310 may be actuated by hydraulic (preferable), electric, air or similar know functionality to facilitate the intended purpose of extending the column so that as a result the vessel 303 is raised, preferably in the range of 30-50 degrees, so that the dry flowable product is moved be gravity to the rotary valve 401 installed on the structure 309 for discharge to a storage location, such as a silo. Preferably, as described generally above, the lift column 301 and rotary feeder 401 are coupled by a hose to a pressurized hydraulic source in order to actuate such devices to perform the intended functionality.

Aerators 319 that are connected to a source of pressurized air may be provided on a bottom of the vessel 303 so that the dry flowable material can be fluidized during delivery and discharge so as to enhance movement of the material when the column 310 is extended, much in the way that the dome lids 308 or a filtration assembly 340 may be openable to atmosphere in other or this embodiment. The hose connected to the pressurized air source is also coupled to the air inlet port of the delivery assembly as described herein.

The loading process is the same as described above and will not be repeated for the sake of brevity, but all of the advantages are equally applicable in this embodiment. The unloading process is slightly different as alluded to and mentioned above. Since the unloading delivery assembly 400 is installed with the vessel 303, i.e., a hydraulically operated (or other power sourced) rotary valve 401 is connected to the transition 313, a single discharge or unload line, hose, conduit, etc. may be connected at the discharge port 402 of the rotary valve 401 to move the materials from the vessel to a desired location. Preferably, the operator confirms that a pressurized air source (either stationary at the customer, recipient, delivery location, or on the tow vehicle) is connected to the aerators and the air inlet port 406, and actuates the air source to move air through the discharge or unload line, hose, conduit, etc. and the aerators 319. Preferably, the operator confirms that a pressurized hydraulic source (either stationary at the customer, recipient, delivery location, or on the tow vehicle) is connected to the lift column 310 and rotary feeder 401. The pressurized hydraulic source is actuated so that the column 310 is moved from a retracted orientation to an extended orientation to facilitate a gravity feed of the dry flowable product into the rotary feeder 401, which is then discharged into the plenum and air carries the product into the storage location. The structure 309 is connected to the wheel and tire assembly 311 so as to permit articulation such that all 8 tires of the wheel and tire assembly remain on the ground for stability.

The above detailed description and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein

1. An apparatus for transportation, storage and delivery for dry flowable material comprising: a vessel disposed within a mobile frame defining parallel top and bottom planes, end planes disposed normal to the top and bottom planes and side planes disposed normal to the end planes; the vessel configured as a hopper for the material disposed therein; the hopper including a top wall parallel to the top plane and bottom walls disposed at an angle with respect to the bottom and top planes; the bottom walls cooperatively define an opening at a lower extent; a valve connected to the bottom walls aligned in registration with the opening that is selectively operable between open and closed orientations; a delivery assembly including a pneumatically operable rotary feeder configured for aligned registration and connection to the valve and a discharge plenum extending from the rotary feeder having an air inlet port and a product discharge port to move the dry flowable material from the vessel to a desired location.

2. The apparatus of claim 1, wherein the hopper includes side walls disposed between the top wall and the bottom walls that are parallel to the side planes.

3. The apparatus of claim 1, wherein the hopper includes end walls disposed between the top wall and the bottom walls that are parallel to the end planes.

4. The apparatus of claim 1, wherein the frame defines an exoskeleton surrounding the vessel, the exoskeleton having exterior dimensions that comply with International Standards Organization Standard ISO 668.

5. The apparatus of claim 1, wherein the frame includes top, bottom end and side panels covering the frame.

6. The apparatus of claim 1, wherein the angle is within the range of 35 degrees and 60 degrees.

7. The apparatus of claim 1, wherein the vessel includes an opening in the top wall and a lid therefor that is configured to move between a closed orientation to retain the material within the vessel and an open orientation to permit material to be deposited into the vessel.

8. A method of delivering a dry flowable material disposed within an apparatus for transportation, storage and delivery of the dry flowable material, the method comprising: providing the apparatus fitted to an intermodal container chassis, wherein the apparatus comprises a vessel disposed within a mobile frame defining parallel top and bottom planes, end planes disposed normal to the top and bottom planes and side planes disposed normal to the end planes; the vessel configured as a hopper for the material disposed therein; the hopper including a top wall parallel to the top plane and bottom walls disposed at an angle with respect to the bottom and top planes; the bottom walls cooperatively define an opening at a lower extent; and a valve connected to the bottom walls aligned in registration with the opening that is selectively operable between open and closed orientations, wherein the frame includes corners that comply with International Standards Organization Standard ISO 1161 to facilitate fitment to the intermodal container chassis; fitting a delivery assembly to the valve, the delivery assembly including a pneumatically operable rotary feeder configured for aligned registration and connection to the valve and a discharge plenum extending from the rotary feeder having an air inlet port and a product discharge port to move the dry flowable material from the vessel to a desired location; connecting a first hose at one end to a pressurized air source and at another end to the rotary feeder; connecting a second hose at one end to the pressurized air source and at another end to the air inlet port; connecting a third hose at one end to the product discharge port and at another end to the desired location; actuating the pressurized air source to actuate the rotary feeder and the valve from the closed orientation to the open orientation to move the dry flowable material from the vessel to a desired location.

9. An apparatus for transportation, storage and delivery for dry flowable material comprising: a vessel connected to a mobile frame; the frame including a king pin to facilitate connection of the frame to a tow vehicle and structure to mount a load-bearing ground-engaging wheel and tire assembly; the vessel configured as a hopper for the material disposed therein; the hopper including a flat top wall and bottom walls disposed at an angle with respect thereto; the bottom walls cooperatively define an opening at a lower extent; a valve connected to the bottom walls aligned in registration with the opening that is selectively operable between open and closed orientations; a delivery assembly including a pneumatically operable rotary feeder configured for aligned registration and connection to the valve and a discharge plenum extending from the rotary feeder having an air inlet port and a product discharge port to move the dry flowable material from the vessel to a desired location.

10. An apparatus for transportation, storage and delivery for dry flowable material comprising: a vessel including a frame, a bulkhead and structure to mount a load-bearing ground engaging wheel and tire assembly; the vessel including a cylindrical portion and a funnel portion for the material disposed therein; the bulkhead connected to the cylindrical portion; the mounting structure connected to the funnel portion; the frame pivotally connected to the vessel adjacent a longitudinal mid-point of the vessel and including mounting block at an opposite end to facilitate connection of the frame to a tow vehicle; the bulkhead including a lift column pivotally connected at a first end thereto and at a second end to the mounting block; the lift column movable between a retracted orientation and an extended orientation; the retracted orientation defined by the frame contiguous with the bulkhead and disposed parallel to a longitudinal axis of the vessel; the extended orientation defined by the frame discontiguous with the bulkhead and disposed at an angle to the longitudinal axis of the vessel; a delivery assembly connected to the funnel portion, the delivery assembly including a hydraulically operable rotary feeder and a discharge plenum extending from the rotary feeder having an air inlet port and a product discharge port to move the dry flowable material from the vessel to a desired location.

11. The apparatus of claim 10, wherein the vessel includes an aerator disposed on a lower portion.

12. The apparatus of claim 10, wherein a first hose is connected at one end to a pressurized hydraulic source disposed on the tow vehicle and at another end to the lift column and at another end to the rotary feeder.

13. The apparatus of claim 10, wherein a second hose is connected at one end to a pressurized air source disposed on the tow vehicle and at another end to an aerator disposed on a lower portion of the vessel and at another end to the air inlet port.

14. A method of delivering a dry flowable material disposed within an apparatus for transportation, storage and delivery of the dry flowable material, the method comprising: providing the apparatus fitted to a tow vehicle, wherein the apparatus comprises a vessel including a frame, a bulkhead and structure to mount a load-bearing ground engaging wheel and tire assembly; the vessel including a cylindrical portion and a funnel portion for the material disposed therein; the bulkhead connected to the cylindrical portion; the mounting structure connected to the funnel portion; the frame pivotally connected to the vessel adjacent a longitudinal mid-point of the vessel and including mounting block at an opposite end to facilitate connection of the frame to the tow vehicle; the bulkhead including a lift column pivotally connected at a first end thereto and at a second end to the mounting block; the lift column movable between a retracted orientation and an extended orientation; the retracted orientation defined by the frame contiguous with the bulkhead and disposed parallel to a longitudinal axis of the vessel; the extended orientation defined by the frame discontiguous with the bulkhead and disposed at an angle to the longitudinal axis of the vessel; a delivery assembly connected to the funnel portion, the delivery assembly including a hydraulically operable rotary feeder and a discharge plenum extending from the rotary feeder having an air inlet port and a product discharge port to move the dry flowable material from the vessel to a desired location; fitting a first hose connected at one end to a pressurized hydraulic source and at another end to the lift column and at another end to the rotary feeder; fitting a second hose connected at one end to a pressurized air source and at another end to the air inlet port; actuating the lift column from the retracted orientation to an extended orientation such that every tire of the wheel and tire assembly remains in contact with the ground; and actuating the rotary feeder to move the dry flowable material from the vessel to a desired location.
